(19) United States
(12) Patent Application Publication
(10) Pub. No.: US 2012/0107688 A1
(43) Pub. Date: May 3, 2012

(54) BINDER FOR LITHIUM ION RECHARGEABLE BATTERY CELLS

(76) Inventor: Melanie J. Loveridge, Sutton Courtenay (GB)

(21) Appl. No.: 13/266,723

(22) PCT Filed: May 7, 2010
(86) PCT No.: PCT/GB2010/000922

§ 371 Date: Jan. 9, 2012

(30) Foreign Application Priority Data
May 11, 2009 (GB) 0908089.6

(51) Int. Cl. H01M 4/62; H01M 4/1395

(52) U.S. Cl. 429/217; 29/623.1; 29/623.5

(57) ABSTRACT

An electrode for a rechargeable battery cell includes a substrate, e.g., a current collector and a particulate silicon forming active material in the electrode, along with a cellulose based binder. At least one chelating agent is provided, the chelating agent being capable of binding to the metallic impurities, e.g., divalent and/or trivalent impurities. The binder is mixed with the silicon particles to form a cohesive mass that adheres to the substrate. It has been found that cellulose based binders can also be used in cells where the active material is silicon if a chelating agent is also incorporated. The electrode can be used in a lithium ion rechargeable battery cell.

### TECHNICAL FIELD

The invention relates to lithium ion rechargeable battery cells and especially to a binder for use in such cells.

### BACKGROUND ART

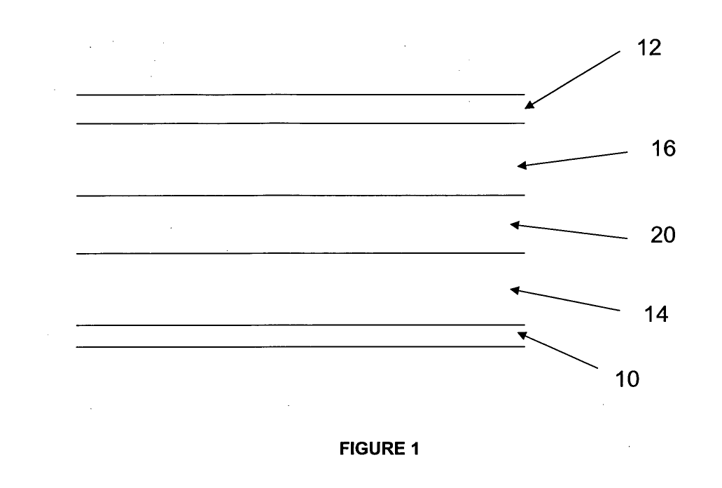

Lithium-ion rechargeable battery cells currently use a carbon/graphite-based anode. The basic composition of a conventional lithium-ion rechargeable battery cell including a graphite-based anode electrode is shown in FIG. 1. A battery may include a single cell but may also include more than one cell.

The battery cell generally comprises a copper current collector 10 for the anode and an aluminium current collector 12 for the cathode, which are externally connectable to a load or to a recharging source as appropriate. It should be noted that the terms “anode” and “cathode” are used in the present specification as those terms are understood in the context of batteries placed across a load, i.e. the term “anode” denotes the negative pole and the term “cathode” the positive pole of the battery. A graphite-based composite anode layer 14 overlays the current collector 10 and a lithium containing metal oxide-based composite cathode layer 16 overlays the current collector 12. A porous plastic spacer or separator 20 is provided between the graphite-based composite anode layer 14 and the lithium containing metal oxide-based composite cathode layer 16: a liquid electrolyte material is dispersed within the porous plastic spacer or separator 20, the composite anode layer 14 and the composite cathode layer 16. In some cases, the porous plastic spacer or separator 20 may be replaced by a polymer electrolyte material and in such cases the polymer electrolyte material is present within both, the composite anode layer 14 and the composite cathode layer 16.

When the battery cell is fully charged, lithium has been transported from the lithium containing metal oxide via the electrolyte into the graphite-based anode where it is intercalated by reacting with the graphite to create a lithium carbon compound, typically LiC₆. The graphite, being the electrochemically active material in the composite anode layer, has a maximum capacity of 372 mAh/g.

It is well known that silicon can be used instead of graphite as the active anode material (see, for example, Insertion Electrode Materials for Rechargeable Lithium Batteries, M. Winter, J. O. Besenhard, M. E. Spahr, and P. Novak in Adv. Mater. 1998, 10, No. 10). It is generally believed that silicon, when used as an active anode material in a lithium-ion rechargeable cell, can provide a significantly higher capacity than the currently used graphite. Silicon, when converted to the compound Li₂₁Si₆ by reaction with lithium in an electrochemical cell, has a maximum theoretical capacity of 4,200 mAh/g, considerably higher than the maximum capacity for graphite. Thus, if graphite can be replaced by silicon in a lithium rechargeable battery, a substantial increase in stored energy per unit mass and per unit volume can be achieved. Unfortunately silicon anode material in Li-ion cells undergoes a huge volume change (up to 300%) between the charged and the discharged states associated with the insertion and removal of lithium ions into the silicon material during the charging and discharging stages of the cells. This is much larger than the volume change seen in carbon anodes.

Carbon black is often added to silicon anodes to increase the conductivity within the electrode.

In both carbon anodes and silicon anodes, the anode material is particulate and the particulate mass is held together in the anode by a binder. It has proved more problematic to find a binder for silicon anodes than for carbon anodes because of this large volume change, which can result in individual silicon particles not always re-establishing electrical contact with each other and with a current collector when the silicon anode shrinks due to the removal of lithium ions during discharging. Therefore the teaching of binders for carbon anodes is not transferable to silicon anodes.

Polyvinylidene fluoride (PVDF) and styrene butadiene rubber (SBR) are the most commonly used binders in lithium-ion rechargeable battery cells using a graphite-based anode, but other binders have been suggested, for example U.S. Pat. No. 5,660,948 discloses the following binders in a carbon anode of a lithium ion cell: ethylene-propylenediene termonomer, PVDF, ethylene-acrylic acid copolymer and ethylene vinyl acetate copolymer. U.S. Pat. No. 6,399,246 teaches that poly(acrylic acid) does not provide good adhesive properties in graphite anodes of lithium-ion battery cells and claims the use of a polyacrylamide binder.

U.S. Pat. No. 6,620,547 discloses a lithium secondary cell having a carbon anode in which lithium may be intercalated and a cathode formed from a transition metal held on a matrix polymer including materials such as polyacrylate, poly(acrylic acid), polymethylmethacrylate, poly(vinyl pyrrolidone), polyacrylonitrile, poly(vinylidene fluoride) and poly(vinyl chloride).

The use of cellulose binders in the fabrication of anodes is known, See, for example, US 20100085685.

U.S. Pat. No. 5,260,148 discloses a lithium secondary cell having an anode formed from a lithium salt that is held together by a binder, which may be starch, carboxymethyl cellulose (CMC), diacetyl cellulose, hydroxypropyl cellulose, ethylene glycol, poly(acrylic acid), polytetrafluoroethylene and poly(vinylidene fluoride).

As mentioned above, the most common binders used in graphite anodes of lithium ion cells are PVDF and SBR but they do not bind silicon anode material together cohesively over successive charging cycles due to the relatively large volume changes of silicon anodes.

An alternative binder that has been proposed for silicon systems is sodium carboxymethylcellulose (NaCMC), see:
(i) Journal of Applied Electrochemistry (2006) 36:1099-1104 (which is primarily concerned with anodes where the active material is a Si/C composite);
(ii) Electrochemical and Solid State Letters, 10 (2) A17-A20 (2007); and
(iii) Electrochemical and Solid State Letters, 8 (2) A100-A103 (2005)

These papers demonstrate that the use of sodium CMC results in an improved cycle life over the ‘standard’ PVdF binder when using micron scale powdered Si anode materials or Si/C composite anode material.

Hitherto, the silicon that has been used in the fabrication of lithium secondary cells has been silicon of the type generally used to fabricate integrated circuit (IC) Si-wafers which has a high purity. However, such silicon is very expensive. In an effort to reduce the cost of the electrodes cheaper, lower grade silicon has been tried but it was found that the resulting electrode mass was unstable and, as a consequence, the resulting anode material, when coated on a current collector, did not retain sufficient contact with the current collector and only underwent a limited number of discharge/recharge cycles, before losing its capacity to hold a charge.

We have found that the lack of stability can be ascribed to certain impurities in the silicon that interact with the NA-CMC. A subsequent search of the literature has reinforced that conclusion since Die Angewandte Makromolekulare Chemie 220 (1994) 123-132 (Nr. 3848) discloses that the viscosity of Na-CMC decreases in the presence of calcium, and aluminium ions.

The use of lower grade metallurgical silicon in the manufacture of cellulose based, particularly CMC based electrodes therefore represents a problem because the metallic impurities present in the silicon interact with the cellulose, particularly CMC binder leading to a loss of stability within the electrode. The present invention addresses that problem.

### DISCLOSURE OF THE INVENTION

In addition to addressing the problem outlined above, it is an object of the present invention to find a binder that can satisfactorily bind together particulate silicon material having differing purities and especially silicon particles made of the relatively cheap “lower grade” silicon in the anode material of a rechargeable lithium ion cell. For example, a relatively cheap form of silicon is Silgrain J230 silicon powder, which has a mean particle diameter of 4.5 μm and comprises one of the Silgrain HQ products, which is commercially available from Elkem of Norway, and which contains the 0.15 following impurities in the following amounts:
Aluminium up to 0.12%
Iron (ferric) up to 0.05%
Calcium up to 0.02%
Titanium up to 0.005%

All percentages given in the present specification are expressed as wt % and based, where appropriate, on dry weights.

Surprisingly, it has been found that sodium carboxymethyl cellulose (NaCMC) (and other cellulose based binders, particularly carboxymethyl celluloses having alternative cations, e.g. other alkali metals), can still be used to form part or the whole of the binder for lower grade silicon (less than 99.90% pure) in the anode of a rechargeable lithium ion cell by incorporating, a chelating agent, typically a divalent and/or trivalent chelating agent, into the anode material. Other multivalent chelating agents such as tetravalent, pentavalent and hexavalent chelating agents may be used. The present invention can also be used with high purity (99.90% pure or above) silicon.

A first aspect of the invention provides an electrode for a lithium ion rechargeable battery cell comprising:
a substrate, e.g. a current collector;
particulate silicon forming active material in the electrode;
a cellulose based binder; and
at least one chelating agent capable of binding to the metallic impurities, e.g. divalent and/or trivalent impurities;
   the binder being mixed with the silicon particles to form a cohesive mass that adheres to the substrate.

The binder can be any cellulose binder that is known to be suitable for inclusion in electrode structures. Examples of such binders are disclosed in US 20100085685 and include methyl cellulose, cellulose sulphate, methylethylcellulose, hydroxyethylcellulose and methyl hydroxypropyl cellulose. Other suitable cellulose binders include binders comprising anionic carboxymethylcellulose, e.g. sodium carboxymethylcellulose. In a preferred embodiment of the first aspect of the invention, the binder is an anionic carboxymethylcellulose, especially sodium carboxymethylcellulose.

The silicon in the electrode could be any suitable form. The particulate silicon is suitably provided in the form of particles, fibres, sheet-like, pillar-like or ribbon-like particles (as described in WO2008/139157) or pillared particles. Fibres can be made using the techniques disclosed in WO2007/083152, WO2007/083155 and WO 2009/010758. Pillared particles are silicon particles on which pillars have been etched using the techniques disclosed in WO2009/010758. Fibres may be obtained by severing the pillars from pillar particles, e.g. using sonification.

For reasons of cost, the silicon used in the present invention is preferably the cheaper silicon having a purity of 99.80% or less, e.g. 99.7% or less, rather than the high purity (and hence more expensive) silicon powder having a purity of at least 99.99% or at least 99.999%. However, the levels of impurities that give rise to problems is believed to be partly determined by the surface area of the silicon probably because a larger surface area leads to an increase in the presence of the impurities at the surface. Therefore it is impossible to give an exact cut-off point between silicon purity levels that will suffer from the above problem and those that will not. Other factors may also be at work.

Nevertheless, the purity of the silicon material should generally be greater than 95.00% in order to ensure that there is sufficient silicon to intercalate the lithium and preferably the purity is greater than 98%. The silicon may include a wide range of impurities, principally iron, aluminium, calcium, titanium, phosphorous and boron oxygen and/or carbon present in an amount of up to about 0.2% each, but generally within the range set out in the table below.

Chemical analysis of Silgrain HQ (the brand that J230 grade belongs to) from a batch analysis reported as below

| | Analysis: | | | | |
|---|---|---|---|---|---|
| | Si | Fe | Al | Ca | Ti |
| | wt % | wt % | wt % | wt % | wt % |
| Max | 99.7 | 0.05 | 0.12 | 0.02 | 0.003 |
| Min | 99.6 | 0.03 | 0.09 | 0.01 | 0.001 |
| Typical | 99.6 | 0.04 | 0.11 | 0.02 | 0.0021 |

The silicon particles may be crystalline for example mono- or poly-crystalline. The polycrystalline particle may comprise any number of crystals for example two or more.

The present invention also has application when other materials within a rechargeable cell having a silicon anode give rise to metallic impurities; for example any carbon black present in the silicon anode to increase the conductivity of the anode. Carbon black typically includes impurities such as iron, which may be in the ferrous or ferric form or both.

The silicon suitably comprises between 20 and 100% of the active material in the electrode. Other active materials may also be included. Examples of active materials that can be used in combination with the silicon include graphite and hard carbon. By the term “active material” it should understood to mean (in the context of lithium ion batteries) a material, which is able to incorporate lithium into and release lithium from its structure respectively during the charging and discharging cycles of the battery. In one embodiment of the first aspect of the invention the electrode comprises 20 to 100% silicon and 0 to 80% of an active material selected from graphite and hard carbon or a mixture thereof. Preferably the active material comprises from 60 to 97% by weight silicon and from 3 to 40% by weight of graphite or hard carbon or a mixture thereof.

The anode material referred to above suitably comprises an active material as described above (e.g. silicon and optionally graphite and/or hard carbon) and a conductive material. Examples of suitable conductive materials include carbon black, acetylene black, ketjen black, channel black; conductive fibres such as carbon fibres (including carbon nanotubes).

The anode material, together with the binder forms a cohesive mass which adheres to the substrate, e.g. current collector; the cohesive mass will generally be in electrical contact with the current collector.

The cohesive mass referred to above suitably comprises 50 to 95% active material, preferably 60 to 90% and especially 70 to 80%.

The cohesive mass suitably comprises 10 to 30% conductive carbon, preferably 8 to 20% and especially 12 to 14%.

The cohesive mass suitably comprises 2 to 20% by weight binder, preferably 8 to 15% by weight and especially 8 to 12% by weight binder. Binder contents of 12% are most preferred. Binder contents of 2-12 wt %, e.g. 5-10 wt. % are also envisaged.

The chelating agents are preferably suitable for chelating trivalent ions, e.g. Fe³⁺ and Al³⁺ and/or divalent ions e.g. Ca²⁺ and Ti²⁺; preferred chelating agents include deferoxamine mesylate, which is a trivalent chelating compound suitable for chelating Fe³⁺ and Al³⁺, EDTA (ethylenediaminetetraacetic acid), which is a general purpose divalent chelator suitable for chelating Ca²⁺ and Co²⁺ and sodium hexametaphosphate (SHMP), which is used as a dispersant and sequestering agent in the water and food industries.

The chelating agent is combined with the anode material (Silicon and optionally other active or conductive materials). The resulting chelating agent/anode material mix can be combined with the cellulose binder in forming the cohesive mass that adheres to the substrate. Alternatively a slurry of the active material in a solution of the chelating agent can be mixed for a predetermined time until the level of impurities in the active materials has reached an acceptable level; the active material can then be separated from the slurry, washed and dried before being mixed with the cellulose binder to form a cohesive mass. It will be appreciated that in the former case, the chelating agent will be included in the electrode structure, whereas in the latter (alternative) case it will not.

The active material comprising, silicon and optionally the conductive material is typically formed into a slurry with an aqueous solution of the chelating agent and stirred for 12 hours. The resulting mixture is then centrifuged for 20 minutes to separate the active material and optionally conductive material. The active material and optionally conductive material is rinsed three times in deionized water (1 L for every 100 g Si). Final separation is carried out in a Buchner funnel apparatus. The silicon in the resulting product typically has a purity of >99%.

In either case, the amounts of the chelating agents present in an anode (either as the slurry mix used to prepare the anode material or in the resulting dried composite electrode after processing) should be sufficient to bind substantially all the cationic impurities. It will generally be necessary to match the valency of the chelating agents with the valency of the impurity.

The chelating agent must itself be stable to the electrochemical environment within a Li-ion cell and for example not interact with other species such as those present in the electrolyte for example lithium ions themselves.

The invention also provides in a second aspect a method of fabricating an electrode, the method comprising the steps of:
a. providing an substrate, e.g. a current collector;
b. providing an active material comprising silicon and optionally a conductive material;
c. mixing a chelating agent with the active material and optionally conductive material;
d. mixing the product of step (c) comprising the active material and optionally the conductive material with a cellulose binder to form a cohesive mass;
e. applying the cohesive mass formed in step (d) to the substrate, e.g. a current collector.

The substrate is preferably a copper current collector. The active material suitably comprises silicon and may optionally comprise other active materials such as graphite or hard carbon or a mixture thereof. Suitable conductive materials include carbon black, acetylene black, ketjen black, channel black; conductive fibres such as carbon fibres (including carbon nanotubes).

Examples of suitable chelating agents are disclosed herein above. The chelating agent is typically provided in the form of a solution and the active material comprising silicon and any conductive material present is dispersed therein to form a slurry. The resulting slurry is then combined with the cellulose binder to form a cohesive mass that can be applied to the substrate, e.g. a current collector.

In a preferred embodiment of the second aspect of the invention, the active material comprising silicon and optionally the conductive material is separated from the chelating agent between steps (c) and (d). The solution containing the chelating agent is discarded and the active material and optionally conductive material is washed and dried before mixing with the binder in step (d).

### Preparation of Sodium Carboxymethylcellulose Solutions

Two solutions of metallurgical grade silicon powder in aqueous solutions of sodium carboxymethylcellulose were prepared.

### Solution A

80 parts by weight of a metallurgical grade silicon powder (Silgrain HQ (J230) from Elkem of Norway having an average particle size of 4.5 μm) was dispersed in 20 parts by weight of a 1% aqueous solution of sodium carboxy methylcellulose having a molecular weight of 700,000.

### Solution B

80 parts by weight of a metallurgical grade silicon powder (Silgrain HQ (J230) from Elkem of Norway having an average particle size of 4.5 μm) was dispersed in 20 parts by weight of an aqueous solution comprising 1% by weight sodium carboxy methylcellulose having a molecular weight of 700,000 and 1% by weight sodium hexametaphosphate.

The viscosity of the sodium carboxymethylcellulose solutions before and after the addition of the sodium powder was determined. The results are presented in Table 1 below:

| Initial Viscosity of NaCMC | | Final Viscosity of NaCMC solution | |
|---|---|---|---|
| of solution mPa/s | | after addition of Silicon mPa/s | |
| Solution A | 340 | Solution A | 20 |
| Solution B+ | 340 | Solution B | 75 |
| (SHMP) | | | |

It can be seen that the viscosity of the sodium carboxymethylcelullose solution for solutions containing the sodium hexametaphosphate is reduced by a much smaller amount compared to solutions in which the hexametaphosphate is absent. This means that dispersions of silicon in solutions of sodium carboxymethylcellulose containing sodium hexametaphosphate are more stable than dispersions in solutions of carboxymethylcellulose in which sodium hexametaphosphate is absent.

1. An electrode for a rechargeable battery cell comprising:
a substrate, e.g. a current collector;
particulate silicon forming active material in the electrode;
a cellulose based binder; and
at least one chelating agent capable of binding to the metallic impurities, e.g. divalent and/or trivalent impurities;
the binder being mixed with the silicon particles to form a cohesive mass that adheres to the substrate.

2. An electrode according to claim 1, wherein the binder is a binder comprising anionic carboxymethylcellulose, e.g. sodium carboxymethylcellulose.

3. An electrode as claimed in claim 1, wherein the silicon has a purity of no more than 99.990% by weight:

4. An electrode as claimed in claim 1 wherein the silicon has a purity no less than 95% by weight.

5. An electrode as claimed in claim 1, wherein the electrode material includes at least one of the following impurities: iron, which may be in ferrous or ferric form or both, aluminium and calcium, which impurities may each be present in an amount of at least 0.001%, e.g. at least 0.01%, based on the total dry weight of the electrode material.

6. An electrode as claimed in claim 1, wherein the at least one chelating agent comprises a divalent, a trivalent and/or a multivalent chelating agent.

7. An electrode as claimed in claim 1, wherein the at least one chelating agent comprises deferoxamine mesylate, ethylenediaminetetraacetic acid (EDTA) and/or sodium hexametaphosphate.

8. An electrode as claimed in claim 1, wherein in respect of chelating agents having any given valency, the amount of such chelating agents present is sufficient to bind substantially all the impurities in the electrode that have a corresponding valency.

9. An electrode as claimed in claim 1, wherein the mixture comprising silicon and binder also includes an electrically conductive carbon.

10. An electrode as claimed in claim 9, wherein conductive carbon includes metallic impurities, e.g. iron, which may be in ferrous or ferric form or both.

11. An electrode as claimed in claim 1, wherein the active material comprises 20 to 100%, by weight, silicon and 0 to 80%, by weight, active carbon e.g. graphite and/or hard carbon.

12. An electrode according to claim 1 wherein the cohesive mass comprises 50 to 95%, by weight, active material.

13. An electrode according to claim 1 wherein the cohesive mass comprises 5 to 20% by weight binder.

14. An electrode according to claim 1 wherein the cohesive mass comprises 10 to 30%, by weight, conductive carbon.

15. An electrode as claimed in claim 1, wherein the particulate silicon in the electrode mass is in the form of pillared particles, powder particles, ribbons or fibres.

16. A rechargeable battery cell including an electrode as claimed claim 1.

17. A device comprising a cell as claimed in claim 16.

18. A method of fabricating an electrode comprising the steps of
a. providing an substrate, e.g. a current collector;
b. providing an active material comprising silicon and optionally a conductive material;
c. mixing a chelating agent with the active material and optionally conductive material;
d. mixing the product of step (c) comprising the active material and optionally the conductive material with a cellulose binder to form a cohesive mass;
e. applying the cohesive mass formed in step (d) to the substrate, e.g. a current collector.

19. A method according to claim 18, which further comprises the step of separating the active material comprising silicon and optionally conductive material from the chelating agent solution between steps (c) and (d).
